(19) United States
(12) Patent Application Publication
(10) Pub. No.: US 2012/0194839 A1
(43) Pub. Date: Aug. 2, 2012

(54) IMAGE FORMING APPARATUS

(75) Inventors: Taisuke MINEMURA, Okazaki-shi (JP); Naoichi Asakura, Shinshiro-shi (JP)

(73) Assignee: Konica Minolta Business Technologies, Inc., Tokyo (JP)

(21) Appl. No.: 13/356,814

(22) Filed: Jan. 24, 2012

(30) Foreign Application Priority Data
Jan. 27, 2011 (JP) 2011-015071

(51) Int. Cl. G06K 15/02

(52) U.S. Cl. 358/1.13

(57) ABSTRACT

An image forming apparatus having: a reader section for reading image data of a document; a printer section for printing the image data read by the reader section as a toner image on a sheet of a print medium; and a cooler section; wherein the printer section comprises a tray for receiving the sheet with the toner image printed thereon; wherein the reader section has an opposed surface opposed to the tray; and wherein the cooler section sucks air outside the printer section and the reader section, sends the air along the opposed surface and blows the air to the sheet being fed to the tray.

This application is based on Japanese Patent Application No. 2011-015071 filed on Jan. 27, 2011, the content of which is incorporated herein by reference.

### BACKGROUND OF THE INVENTION

1. Field of the Invention

The present invention relates to an image forming apparatus, and more particularly to an image forming apparatus comprising a reader section and a printer section.

2. Description of Related Art

An example of conventional image forming apparatuses is an image forming apparatus shown by FIG. 6 of Japanese Patent Laid-Open Publication No. 2007-264416. The image forming apparatus has a reader and an image forming section. The reader is a scanner for reading image data of a document. The image forming section is located under the reader and prints a toner image on a recording sheet. Further, a printed-sheet stacking section for stacking printed sheets thereon is provided above the image forming section.

In the image forming apparatus described in Japanese Patent Laid-Open Publication No. 2007-264416, in order to prevent printed sheets stacked on the printed-sheet stacking section from sticking to each other, a cooling fan is provided near an ejection port of the image forming apparatus. This is described in more detail. Recording sheets are subjected to a heating treatment by a fixing device provided in the image forming apparatus, and thereby, toner on a recording sheet immediately after passing through the fixing device is in a molten state. The recording sheet with the molten toner thereon is ejected onto the printed-sheet stacking section, and while the toner is hardening, the recording sheet sticks to another recording sheet. In order to avoid this trouble, in the image forming apparatus described in Japanese Patent Laid-Open Publication No. 2007-264416, each recording sheet is cooled by the cooling fan before ejected onto the printed-sheet stacking section, thereby preventing each recording sheet from being ejected onto the printed-sheet stacking section with molten toner thereon.

However, the image forming apparatus described in Japanese Patent Laid-Open Publication No. 2007-264416 has a problem that when the image forming apparatus is continuously used for a long time, the reading performance of the reader is likely to degrade. This is described in more detail. The reader reads image data of a document by irradiating the document and receiving, on an image pick-up element such as a CCD, light reflected from the document. For this purpose, the reader has a built-in light source. When the reader is continuously used for a long time, the light source generates a large amount of heat, and due to the heat, optical elements of the reader may be deformed. In the image forming apparatus described in Japanese Patent Laid-Open Publication No. 2007-264416, further, the reading performance of the reader may degrade due to heat transmitted from the image forming section.

### SUMMARY OF THE INVENTION

An image forming apparatus according to an embodiment of the present invention comprises: a reader section for reading image data of a document; a printer section for printing the image data read by the reader section as a toner image on a sheet of a print medium; and a cooler section; wherein the printer section comprises a tray for receiving the sheet with the toner image printed thereon; wherein the reader section has an opposed surface opposed to the tray; and wherein the cooler section sucks air outside the printer section and the reader section, sends the air along the opposed surface and blows the air to the sheet being fed to the tray.

### BRIEF DESCRIPTION OF THE DRAWINGS

The features of the present invention will be apparent from the following description with reference to the accompanying drawings, in which:

FIG. 1 is a skeleton framework of an image forming apparatus;

FIG. 2 is a schematic outline view of a cooler section;

FIG. 3 is another schematic outline view of the cooler section;

FIG. 4 is a schematic outline view of a fan provided in the cooler section; and

FIG. 5 is a schematic outline view of the cooler section attached to a scanner and a printer section.

### DETAILED DESCRIPTION OF THE PREFERRED EMBODIMENTS

An image forming apparatus according to an embodiment of the present invention is hereinafter described.

### Structure of the Image Forming Apparatus

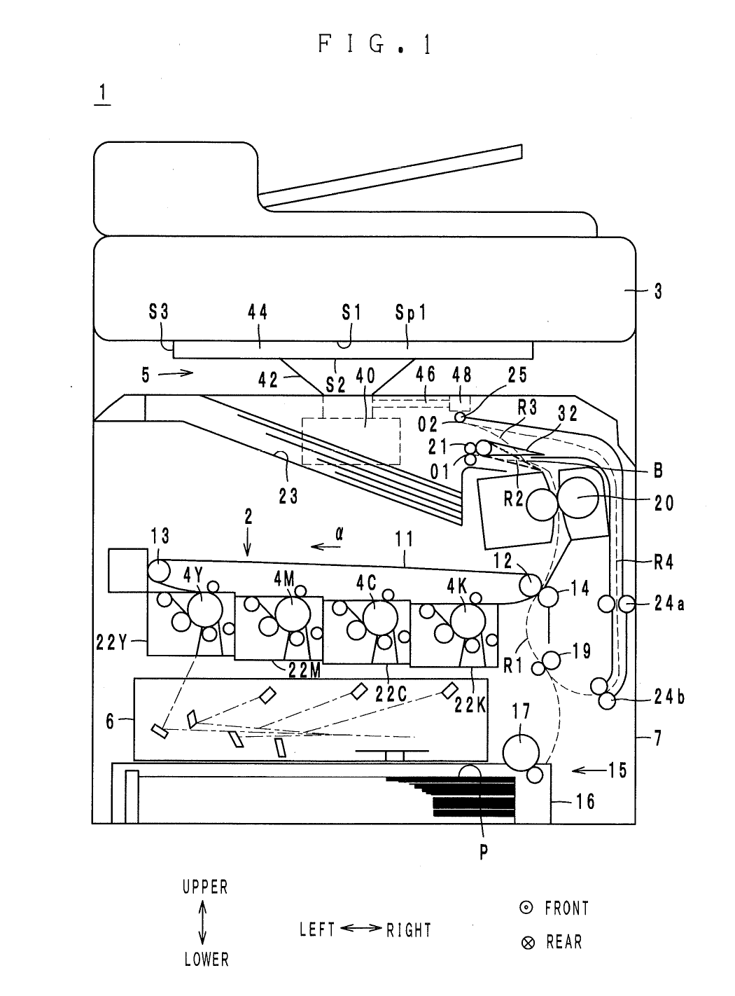

With reference to the drawings, an image forming apparatus according to an embodiment of the present invention is described. FIG. 1 shows the overall structure of the image forming apparatus 1. In the following paragraphs, the words, “upward”, “downward”, “upper” and “lower” are used with respect to the vertical direction. The words, “front” and “rear” mean respectively the front and the rear of the image forming apparatus 1, and the words, “right” and “left” mean respectively the right and the left of the image forming apparatus 1.

The image forming apparatus 1 is an electrophotographic color printer and combines images of four colors, namely, yellow (Y), magenta (M), cyan (C) and black (K) by a tandem method. The image forming apparatus 1 comprises a scanner 3, a cooler section 5 and a printer section 7.

The scanner 3 is to read image data of a document and has a lower surface S1. The printer section 7 is to print a toner image on a sheet of a print medium in accordance with the image data read by the scanner 3, and as shown by FIG. 1, the printer section 7 is located under the scanner 3. The printer section 7 comprises an image forming section 2, a feeding section 15, a pair of timing rollers 19, a fixing device 20, a pair of ejection rollers 21, a printed-sheet tray 23, pairs of conveying rollers 24a and 24b, a reversing roller 25, a switch 32 and conveyance routes R1 to R4.

The feeding section 15 feeds sheets of a print medium P one by one. The feeding section 15 comprises a sheet tray 16 and a feed roller 17. On the sheet tray 16, a plurality of sheets P to be subjected to printing are stacked. The feed roller 17 picks up one sheet from the stack of sheets P on the sheet tray 16.

The pair of timing rollers 19 feeds the sheet P upward in synchronized timing so that a toner image can be transferred onto the sheet P at the image forming section 2.

The image forming section 2 forms a toner image on the sheet P fed from the feeding section 15. The printer section 2 comprises an optical scanning device 6, an intermediate transfer belt 11, a driving roller 12, a driven roller 13, a secondary transfer roller 14 and image formation units 22 (22Y, 22M, 22C, 22K). The image formation units 22 (22Y, 22M, 22C, 22K) each have a photosensitive drum 4 (4Y, 4M, 4C, 4K).

The photosensitive drums 4 (4Y, 4M, 4C, 4K) are cylindrical. The peripheral surfaces of the photosensitive drums 4 are scanned with beams from the optical scanning device 6, and thereby, electrostatic latent images are formed on the peripheral surfaces of the photosensitive drums 4. Thereafter, the electrostatic latent images are developed into toner images by developing devices (not shown). Since the process of forming an electrostatic latent image and the process of developing the electrostatic latent image into a toner image are well known, and a detailed description thereof is omitted.

The intermediate transfer belt 11 is stretched between the driving roller 12 and the driven roller 13. The toner images formed on the photosensitive drums 4 are transferred and combined on the intermediate transfer belt 11 to be formed into a composite toner image (primary transfer). The driving roller 12 is rotated by an intermediate transfer belt driving section (not shown) and drives the intermediate transfer belt 11 in a direction shown by arrow α. Thereby, the intermediate transfer belt 11 carries the composite toner image to the secondary transfer roller 14.

The secondary transfer roller 14, which is cylindrical, is located in such a position to face to the intermediate transfer roller 11. A transfer voltage is applied to the secondary transfer roller 14, and thereby, the composite toner image carried by the intermediate transfer belt 11 is transferred onto a sheet P passing through between the intermediate transfer belt 11 and the secondary transfer roller 14 (secondary transfer).

The sheet P with the toner image transferred thereon is fed to the fixing device 20. The fixing device 20 performs a heating treatment and a pressing treatment toward the sheet P, and thereby, the toner image is fixed on the sheet P. Thereafter, the sheet P is ejected by the pair of ejection rollers 21 onto the printed-sheet tray 23 through an opening O1. The printed-sheet tray 23 faces right upward and is opposed to the lower surface S1 of the scanner 3. Printed sheets P with toner images printed thereon are stacked on the printed-sheet tray 23.

The image forming apparatus 1 is of a structure for permitting double-side printing of a sheet P. More specifically, for double-side printing, the image forming apparatus 1 performs printing on one side of a sheet P, reverses the sheet P and performs printing on the other side of the sheet P.

In the image forming apparatus 1, the conveyance route R1 is from the feeding section 15 to a diverging point B immediately downstream from the fixing device 20 with respect to the sheet conveyance direction. The conveyance route R1 is formed of guides (not shown). On the conveyance route R1, the pair of timing rollers 19, the image forming section 2 and the fixing device 20 are arranged in this order from upstream to downstream with respect to the sheet conveyance direction. The conveyance routes R2 and R3 branch off from the conveyance route R1 at the diverging point B.

The conveyance route R2 is from the diverging point B to the pair of ejection rollers 21. The conveyance route R2 is formed of guides (not shown). On the conveyance route R2, the pair of ejection rollers 21 is arranged.

The conveyance route R3 extends from the diverging point B more upward than the conveyance route R2 and reaches to the outside of the printer section 7. The conveyance route R3 is formed of guides (not shown). The reversing roller 25 is located at the downstream edge of the conveyance route R3 with respect to the sheet conveyance direction. The reversing roller 25 feeds back a sheet P above the printed-sheet tray 23 so that the sheet P can be turned over. More specifically, the reversing roller 25 feeds the sheet P out from the printer section 7 through an opening O2, and reverses the sheet P to feed the sheet P back into the conveyance route R4.

The conveyance route R4 is connected with the conveyance route R3 and joins the conveyance route R1 at an upstream point from the pair of timing rollers 19 with respect to the sheet conveyance direction. More specifically, the conveyance route R4 diverges from the conveyance route R3 at the reversing roller 25. The conveyance route R4 is formed of guides (not shown). On the conveyance route R4, a pair of conveyance rollers 24a and a pair of conveyance rollers 24b are arranged in this order from upstream to downstream with respect to the sheet conveyance direction. The pairs of conveyance rollers 24a and 24b convey the sheet P to the conveyance route R1.

The switch 32 is located at the diverging point B of the conveyance routes R2 and R3. The switch 32 switches the route for the sheet P fed through the conveyance route R1 between the conveyance routes R3 and R4. More specifically, in order to turn over the sheet P to subject the sheet P to printing on the reverse side, the switch 32 closes the conveyance route R2 as shown by the dotted line in FIG. 1. In this state, the sheet P is guided into the conveyance route R3. Then, after completion of the printing on the reverse side of the sheet P, the switch 32 closes the conveyance route R3 as shown by the solid line in FIG. 1. In this state, the sheet P is guided into the conveyance route R2.

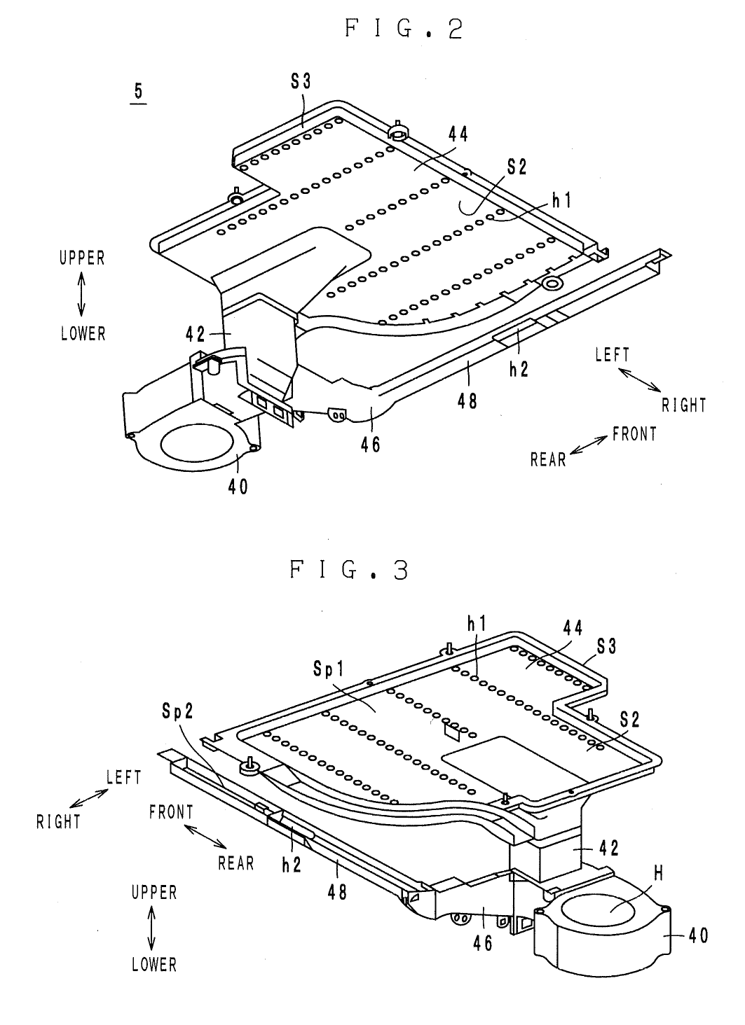

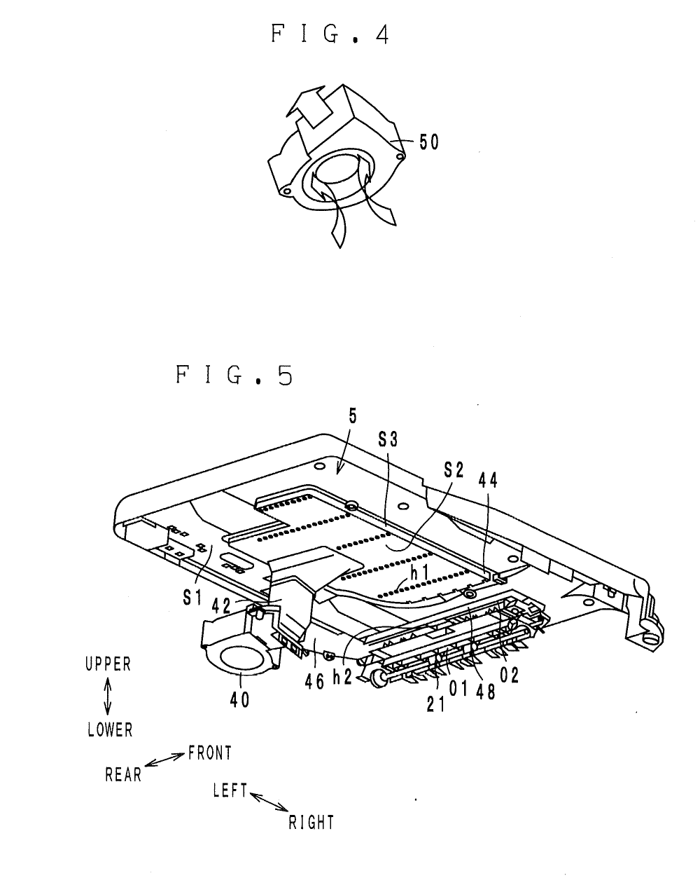

The cooler section 5 sucks air from the outside of the scanner 3 and the printer section 7, and blows the air along the lower surface S1 of the scanner 3 to a sheet P that is being fed to the printed-sheet tray 23. The cooler section 5 is hereinafter described in more detail. FIGS. 2 and 3 are schematic outline views of the cooler section 5. FIG. 2 is a view of the cooler section 5 taken from the upper side, and FIG. 3 is a view of the cooler section 5 taken from the lower side. FIG. 4 is a schematic outline view of a fan 50 provided in the cooler section 5. FIG. 5 is a schematic outline view of the cooler section 5 in a state that the cooler section 5 is attached to the scanner 3 and the printer section 7. The lower part of the printer section 7 from the pair of ejection rollers 21 is not shown in FIG. 5 so that the whole cooler section 5 can be shown.

As shown in FIGS. 2 and 3, the cooler section 5 comprises a sucker 40, a duct 42, a circulator (a space forming member) 44, a duct 46 and an air blower 48. The sucker 40 sucks air from the outside of the scanner 3 and the printer section 7, and incorporates the fan 50 shown by FIG. 4. More specifically, the sucker 40 is a cylinder having an opening H on the upper side. The fan 50 comprises a motor and a rotary impeller, and takes in air through the opening H.

The duct 42 is a vertically extending pipe. The lower end of the duct 42 is connected to the sucker 40. The circulator 44 is composed of a main surface S2 and side surfaces S3 enclosing the main surface S2, and the circulator 44 is shaped like a tray having the main surface S2 as a bottom surface and the side surfaces S3 as side walls. As shown by FIG. 5, the circulator 44 is attached to the scanner 3 such that the main surface S2 is opposed to the lower surface S1 of the scanner 3. Thereby, under the lower surface S1 of the scanner 3, a space Sp1 enclosed by the lower surface S1 of the scanner 3, the main surface S2 and the side surfaces S3 of the circulator 4 is formed. The upper end of the duct 42 is connected to the main surface S2 of the circulator 44. In this structure, the air sucked by the fan 50 and taken into the sucker 40 is introduced into the space Sp1 through the duct 42 and is circulated in the space Sp1.

The main surface S2 of the circulator 44 is also opposed to the printed-sheet tray 23. In the main surface S2 of the circulator 44, holes h1 are made. With this arrangement, the air that was introduced into the space Sp1 and that was circulated therein is blown through the holes h1 to the sheet P being fed to the printed-sheet tray 23. In the image forming apparatus 1 according to this embodiment, a multiple of holes h1 are made in the main surface S2 entirely. Therefore, the air is blown to the entire surface of the sheet P.

The duct 46 is a horizontally extending pipe. The left end of the duct 46 is connected to the sucker 40. The air blower 48 is a rectangular parallelepiped extending in the front-to-rear direction. The air blower 48 is located above the pair of ejection rollers 21 and the reversing roller 25. The upper side of the air blower 48 is open as shown in FIG. 3. However, as shown by FIG. 5, the open side of the air blower 48 is closed by a case of the printer section 7. Therefore, a space Sp2 enclosed by the case of the printer section 7 and the air blower 48 is formed. The rear end of the air blower 48 is connected to the right end of the duct 46. In this structure, the air sucked by the fan 50 and taken into the sucker 40 is introduced into the space Sp2 via the duct 46.

In the lower surface of the duct 46, holes h2 are made. With this arrangement, the air that was introduced into the space Sp2 is blown through the holes h2 to a sheet P that is being ejected onto the printed-sheet tray 23 through the pair of ejection rollers 21 or to a sheet P that is being ejected from the printer section 7 through the reversing roller 25.

### Advantages

In the image forming apparatus 1 according to this embodiment, air is blown from the spaces Sp1 and Sp2 through the holes h1 and h2 to a sheet P that is being fed to the printed-sheet tray 23 through the pair of ejection rollers 21. Further, air is blown through the holes h1 to sheets P stacked on the printed-sheet tray 23. Thereby, the sheets P are cooled by the air, and toner on the sheets P hardens. Consequently, the sheets P stacked on the printed-sheet tray 23 are prevented from sticking to each other.

In the image forming apparatus 1, the cooler section 5 sends the air sucked from the outside of the scanner 3 and the printer section 7 along the lower surface S1 of the scanner 3. Then, the scanner 3 is cooled by the air. Consequently, the scanner 3 is prevented from degrading in the reading performance.

In the image forming apparatus 1, also, dew condensation on the lower surface S1 of the scanner 3 can be prevented. This is described in mode detail. Air is blown through the holes h1 and h2 to a sheet P that is being ejected onto the printed-sheet tray 23 through the pair of ejection rollers 21. Further, air is blown through the holes h1 to the sheets P stacked on the printed-sheet tray 23. Thereby, the sheets stacked on the printed-sheet tray 23 cool down, and accordingly, water evaporation from the sheets P is prevented. Consequently, dew condensation on the lower surface S1 of the scanner 3 is prevented.

Moreover, in the image forming apparatus 1, dew condensation in the conveyance route R4 can be prevented. This is described in more detail. Air is blown through the holes h1 and h2 to a sheet P that is being reversed above the printed-sheet tray 23 by the reversing roller 25. After the air blow to the sheet P through the holes h1 and h2, the sheet P is reversed and fed into the conveyance route R4 by the reversing roller 25. Therefore, when the sheet P comes into the conveyance route R4, the sheet P cools down. Accordingly, water evaporation from the sheet P is prevented from occurring in the conveyance route R4, and consequently, dew condensation in the conveyance route R4 is prevented.

### OTHER EMBODIMENTS

The rotating speed of the fan 50 does not have to be constant. The image forming apparatus 1 may have a control section (not shown) that increases the rotating speed of the fan 50 when the surrounding temperature of the image forming apparatus 1 is relatively high and/or when the number of printed sheets P to be made by the image forming apparatus 1 is relatively large. In this case, further, the fan 50 may be controlled to continuously run for a specified time after completion of the printing operation. On the other hand, when the surrounding temperature of the image forming apparatus 1 is relatively low and/or when the number of printed sheets P to be made by the image forming apparatus 1 is relatively small, the fan 50 may be controlled to rotate at a lower speed or to stop rotating.

Further, the air sucked by the sucker 40 may be blown not only to the sheets P but also to parts of the image forming apparatus 1, such as the conveyance routes R3 and R4, the pair of ejection rollers 21, the reversing roller 25 and the like.

Although the present invention has been described in connection with the preferred embodiment above, it is to be noted that various changes and modifications are possible to those who are skilled in the art. Such changes and modifications are to be understood as being within the scope of the present invention.

What is claimed is:

1. An image forming apparatus comprising:
a reader section for reading image data of a document;
a printer section for printing the image data read by the reader section as a toner image on a sheet of a print medium; and
a cooler section;
wherein the printer section comprises a tray for receiving the sheet with the toner image printed thereon;
wherein the reader section has an opposed surface opposed to the tray; and
wherein the cooler section sucks air outside the printer section and the reader section, sends the air along the opposed surface and blows the air to the sheet being fed to the tray.

2. An image forming apparatus according to claim 1,
wherein the cooler section comprises:
a sucker for sucking air outside the printer section and the reader section; and
a space forming member for forming a space for circulation of the air above the opposed surface;
wherein the air is blown through a hole made in the space forming member to the sheet being fed to the tray.

3. An image forming apparatus according to claim 2, wherein a multiple of holes are made entirely in the space forming member.

4. An image forming apparatus according to claim 2, wherein a part of the space forming member with the hole is located over an opening through which the sheet with the toner image printed thereon is fed to the tray.

5. An image forming apparatus according to claim 2, wherein the cooler section further comprises an air blower for blowing the air sucked by the sucker to the sheet being fed to the tray.

6. An image forming apparatus according to claim 5,
wherein the printer section further comprises a reverser for feeding back the sheet above the tray so as to turn over the sheet; and
wherein the air blower blows the air to the sheet being fed back above the tray by the reverser.
